(19) United States
(12) Patent Application Publication
(10) Pub. No.: US 2011/0267999 A1
(43) Pub. Date: Nov. 3, 2011

(54) BUFFER CONTROLLER AND RADIO COMMUNICATION TERMINAL

(76) Inventor: Yuji Kuwahara, Kanagawa (JP)

(21) Appl. No.: 13/143,145

(22) PCT Filed: Jun. 16, 2009
(86) PCT No.: PCT/JP2009/002745

§ 371 Date: Jul. 1, 2011

(30) Foreign Application Priority Data
Jan. 16, 2009 (JP) 2009-007748 2009

(51) Int. Cl. H04L 12/56; H04W 4/00

(52) U.S. Cl. 370/310; 370/394

(57) ABSTRACT

Providing a buffer controller and a radio communication terminal capable of absorbing jitter. The buffer controller according to the present invention corresponds to a buffer controller provided in a communication terminal having a reception section which receives data through a network includes: a first data processing section which includes a first buffer that, in order to rearrange the data received by the receiver in a correct sequence, stays the data, and which performs a process of rearranging the data that are stayed in the first buffer, in the correct sequence; a second data processing section which includes a second buffer that buffers the data processed in the first data processing section, and which performs a process of outputting the data buffered in the second buffer, in accordance with a predetermined output rate; and a controller which, based on an amount of the data stayed in the first buffer, controls at least a capacity of the second buffer.

### TECHNICAL FIELD

The present invention relates to a buffer controller and a radio communication terminal which are capable of absorbing jitter.

### BACKGROUND ART

In an IP (Internet Protocol) network typified by the Internet, recently, services to deliver sound and images in real time are provided. In a service to deliver sound and images in real time, packet data are delivered on a best effort basis. In the service to deliver sound and images in real time, therefore, it is not guaranteed that packet data reach the destination in a predetermined sequence and within a predetermined time period. Consequently, there is a so-called QoS (Quality of Service) controlling technique for controlling packet data communication while giving priority to a used channel.

Particularly, packets constituting audio and video data (hereinafter, referred to as AV data) to be stream-reproduced must be transmitted through a high-priority channel and in real time in order to prevent image and sound qualities from deteriorating in stream reproduction. Therefore, an RTP (Real-time Transport Protocol) is usually used as a transmission protocol for transmitting AV data for stream reproduction. In the QoS controlling technique, even when priority is given to a channel in which packet communication is performed, however, there is a case where jitter occurs at a time when a packet reaches a radio communication terminal. Therefore, it is sometimes difficult to, in real time, reproduce AV data for stream reproduction contained in a packet, in a radio communication terminal.

The operation of a radio communication terminal in the case where such jitter occurs will be described.

In a wireless network, in the case where the strength of the electric field between a radio communication terminal and a base station is low, errors randomly occur in a packet which is received from the base station by the radio communication terminal. Even when the radio communication terminal performs a decoding process and an error correction process on the packet, therefore, the terminal cannot sometimes decode the packet by error correction (i.e., decoding error occurs). In order to compensate such a decoding error, in the case where the radio communication terminal determines that the packet cannot be decoded, the radio communication terminal automatically transmits a NACK indicative of a decoding error, to the base station which is the transmission source. The base station which receives the NACK retransmits the packet in which the decoding error has occurred, to the radio communication terminal. As such a retransmission control, the HARQ control is known. Typical examples of the HARQ control are HSDPA (High Speed Downlink Packet Access) stipulated in 3GPP (Third Generation Partnership Project), and LTE (Long Term Evolution) which is a next generation communication standard.

FIG. 7 shows an aspect in which packets that are retransmitted from a base station 900 by the HARQ control are accumulated in buffers of a radio communication terminal 800. Referring to FIG. 7, a method of processing packets in the radio communication terminal 800 will be described.

The radio communication terminal 800 sequentially processes packets 1 to 3 which are normally error-corrected and decoded by decoding and error correction processes, and accumulates the packets in an RTP buffer.

With respect to packet 4 in which a decoding error is caused as a result of the decoding and error correction processes, then, the radio communication terminal 800 transmits a NACK to a base station 900 which is the transmission source, through a wireless network. Since the packet 4 is missed, furthermore, the radio communication terminal 800 keeps packet 5 and packet 6 to be stayed in an RLC buffer.

When the radio communication terminal 800 then again receives the packet 4 from the base station 900, the terminal processes the packet 4 together with the packet 5 and packet 6 which are accumulated in the RLC buffer, and performs a control of rearranging the packets in the correct sequence. Thereafter, the radio communication terminal 800 transfers the packets 4 to 6 which are rearranged in the correct sequence, to the RTP buffer.

Moreover, the radio communication terminal 800 performs processes which are similar to those on the packets 4 to 6, on packets 7 to 9.

With respect to packet 7 in which a decoding error is caused as a result of the decoding and error correction processes, namely, the radio communication terminal 800 transmits a NACK to the base station 900 which is the transmission source, through the wireless network. Since the packet 7 is missed, furthermore, the radio communication terminal 800 keeps packet 8 and packet 9 to be stayed in the RLC buffer.

When the radio communication terminal 800 then again receives the packet 7 from the base station 900, the terminal processes the packet 7 together with the packet 8 and packet 9 which are accumulated in the RLC buffer, and performs a control of rearranging the packets in the correct sequence. Thereafter, the radio communication terminal 800 transfers the packets 7 to 9 which are rearranged in the correct sequence, to the RTP buffer.

As described above, the packets 5 and 6 and the packets 8 and 9 are stayed in the RLC buffer until the packet 4 and the packet 7 are enabled to be decoded. Because of such staying of packets, a time period when packets are not processed is generated between the transfer of the packet 3 which immediately precedes the packet 4, to the RTP buffer, and that of the packet 4 which is again received, and the packets 5 to 6 to the RTP buffer. This time period corresponds to jitter. The jitter includes the time period which extends until a missed packet is retransmitted by the HARQ retransmission control, that when packets are stayed in the RLC buffer, that when packets are subjected to the RLC process and transferred to the RTP layer, and the like.

When the jitter is long, the amount of RTP packets which are to be converted to audio and video data by a decoder becomes insufficient. As a result, in the radio communication terminal 800, the output rates of sound and images are lowered, and sound interruption and image deterioration are caused. In the case where packets constitute AV data for stream reproduction, particularly, sound interruption and image deterioration are noticeable.

### CITATION LIST

### Patent Literature

Patent Literature 1: JP-A-2008-028828

### SUMMARY OF THE INVENTION

### Technical Problem

In the buffer control technique disclosed in Patent Literature 1, the capacity of an RTP buffer is changed in accordance with the strength of the electric field between a radio communication terminal and a base station. Therefore, it is possible to absorb jitter of the reception interval of RTP packets, and sound interruption hardly occurs. Actually, however, the time width of above-described jitter is very larger than the variation time width of one to several ms of the strength of the electric field between a radio communication terminal and a base station. Therefore, it is considered that jitter which can be absorbed by changing the capacity of the RTP buffer does not largely depend on the electric field between the radio communication terminal and the base station.

It is an object of the invention to provide a buffer controller and radio communication terminal which are capable of absorbing jitter.

### Solution to Problem

The present invention provides a buffer controller provided in a communication terminal having a receiver that receives data through a network, the buffer controller including: a first data processing section which includes a first buffer that, in order to rearrange the data received by the receiver in a correct sequence, stays the data, and which performs a process of rearranging the data that are stayed in the first buffer, in the correct sequence; a second data processing section which includes a second buffer that buffers the data processed in the first data processing section, and which performs a process of outputting the data buffered in the second buffer, in accordance with a predetermined output rate; and a controller which, based on an amount of the data stayed in the first buffer, controls at least a capacity of the second buffer.

According to the configuration, the capacity of the second buffer which absorbs jitter in reception of packets can be set to an appropriate value.

In the buffer controller, the controller controls the second processing section so as to, as a staying amount of the data which is stayed in the first buffer is larger, further increase the capacity of the second buffer.

In the buffer controller, the controller controls the second processing section so as to, as the staying amount of the data which is stayed in the first buffer is smaller, further decrease the capacity of the second buffer.

The buffer controller further includes a decoder which converts the data processed in the second data processing section, to an audio signal and a video signal, and, in a case where a data amount of the data per unit of time which are output from the second data processing section to the decoder is smaller than an output rate that is preset to a predetermined value, the controller controls the first processing section so as to output the data stayed in the first buffer, to the second buffer.

According to the configuration, the rate of the output from the second buffer to the decoder can be prevented from being lowered.

The present invention also provides a radio communication terminal including the buffer controller as mentioned above.

### Advantageous Effects of the Invention

According to the buffer controller and radio communication terminal of the invention, it is possible to absorb jitter.

### BRIEF DESCRIPTION OF THE DRAWINGS

FIG. 1 is a block diagram of a radio communication terminal 100 according to a first embodiment of the invention.

FIG. 2 shows an aspect in which packets are accumulated in buffers of the radio communication terminal 100.

FIG. 3 shows temporal transition of the staying amount of RLC packets in an RLC buffer 133.

FIG. 4 shows temporal transition of the process delay (jitter) in an RTP buffer 137.

FIG. 5 is a block diagram of the configuration of a radio communication terminal 300 according to a second embodiment.

FIG. 6 shows temporal transition of the remaining amount of RTP packets in an RTP buffer 337.

FIG. 7 shows an aspect in which packets that are retransmitted by the HARQ control are accumulated in buffers.

### DESCRIPTION OF THE EMBODIMENTS

Hereinafter, embodiments of the invention will be described with reference to the drawings.

### Embodiment 1

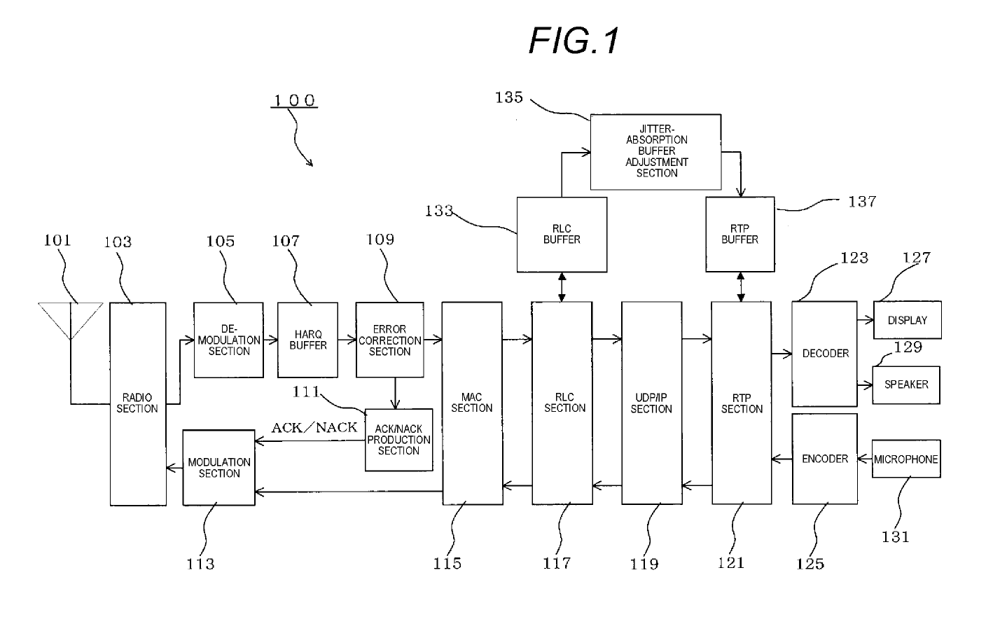

FIG. 1 is a block diagram of a radio communication terminal 100 according to a first embodiment of the invention. As shown in FIG. 1, the radio communication terminal 100 includes an antenna 101, a radio section 103, a demodulation section 105, an HARQ buffer 107, an error correction section 109, an ACK/NACK production section 111, a modulation section 113, a MAC section 115, an RLC section 117, a UDP/IP section 119, an RTP section 121, a decoder 123, an encoder 125, a display 127, a speaker 129, a microphone 131, an RLC buffer 133, a jitter-absorption buffer adjustment section 135, and an RTP buffer 137.

Referring to FIG. 1, the components of the radio communication terminal 100 will be described.

The antenna 101 converts a radio wave which is received from a base station 200 through a wireless network, into a radio signal. Furthermore, the antenna 101 converts a signal which is transferred from the radio section 103, into a radio wave, and transmits the radio wave to the base station 200. The radio section 103 converts the radio signal which is converted by the antenna 101, and which has a carrier frequency, into a radio signal in a frequency band for the demodulation section 105. Moreover, the radio section converts a signal which is transferred from the modulation section 113, into a signal in a carrier frequency, and transmits the converted signal to the antenna 101.

The demodulation section 105 demodulates the radio signal which is transferred from the radio section 103. Then, the demodulation section 105 transfers the demodulated signal to the HARQ buffer 107.

The demodulation section 102 demodulates the radio signal which is transferred from the radio section 101. Then, the demodulation section 102 transfers the demodulated signal to the HARQ buffer 107.

The error correction section 109 performs an error correction and decoding process on signals (hereinafter, referred to as packets) accumulated in the HARQ buffer 107. The error correction section 109 performs, for example, a CRC (Cyclic Redundancy Check) check to determine the result of error correction of packets accumulated in the HARQ buffer 107. In the first embodiment, packets constitute AV data for stream reproduction.

Based on the result of error correction of the error correction section 109, the ACK/NACK production section 111 determines whether packets can be decoded or not. If packets cannot be decoded, the ACK/NACK production section 111 transfers a NACK to the modulation section 113. If packets can be decoded, the ACK/NACK production section 111 transfers an ACK to the modulation section 113.

The modulation section 113 modulates the NACK or ACK which is transferred from the ACK/NACK production section 111. The radio section 103 converts the frequency of the NACK or ACK which is modulated in the modulation section 113, into the carrier frequency. The antenna 101 converts the NACK or the ACK into a radio wave, and transmits the radio wave to the base station 200 through the wireless network. When the base station 200 receives the NACK, the base station 200 retransmits the signal in which a decoding error is caused in the error correction section 109, after an elapse of a predetermined time period.

The MAC section 115 extracts RLC packets from the decodable packets decoded and error-corrected in the error correction section 109. Then, the MAC section 115 transfers the RLC packets to the RLC section 117.

In order to perform a sequential control on the RLC packets, the RLC section 117 accumulates the RLC packets in the RLC buffer 133. When the sequence of the RLC packets which are accumulated in the RLC buffer 133 is correct, the RLC section 117 sequentially transfers the RLC packets to the UDP/IP section 119. When the sequence of the RLC packets which are accumulated in the RLC buffer 133 is not correct, the RLC section 117 stays the RLC packets in the RLC buffer 133 until a missing packet is transferred from the MAC section 115.

The UDP/IP section 119 analyzes the IP/UDP headers of the RLC packets which are transferred from the RLC section 117. Furthermore, the UDP/IP section 119 extracts RTP packets from the RLC packets which are transferred from the RLC section 117. Then, the UDP/IP section 119 transfers the RTP packets to the RTP section 121.

In accordance with the capacity of the RTP buffer 137 which is instructed by the jitter-absorption buffer adjustment section 135, the RTP section 121 accumulates the RTP packets which are transferred from the RTP section 121, in the RTP buffer 137. In accordance with a predetermined output rate, furthermore, the RTP section 121 transfers the RTP packets which are accumulated in the RTP buffer 137, to the decoder 123.

The decoder 123 converts the RTP packets which are transferred from the RTP section 121, to an audio signal or a video signal. The decoder 123 transfers the audio signal to the speaker 129. Furthermore, the decoder 123 transfers the video signal to the display 127. The display 127 displays the video signal which is transferred from the decoder 123, in the form of a video. The speaker 129 outputs the audio signal which is transferred from the decoder 123, in the form of sound.

The jitter-absorption buffer adjustment section 135 reads the data amount of the RLC packets which are stayed in the RLC buffer 133. In accordance with the staying amount of the RLC packets which are stayed in the RLC buffer 133, the jitter-absorption buffer adjustment section 135 controls the capacity of the RTP buffer 137. In the case where the staying amount of the RLC packets which are stayed in the RLC buffer 133 is large, for example, the jitter-absorption buffer adjustment section 135 controls the RTP buffer 137 so as to increase the capacity of the RTP buffer 137. In the case where the staying amount of the RLC packets which are stayed in the RLC buffer 133 is small, the jitter-absorption buffer adjustment section 135 controls the RTP buffer 137 so as to decrease the capacity of the RTP buffer 137.

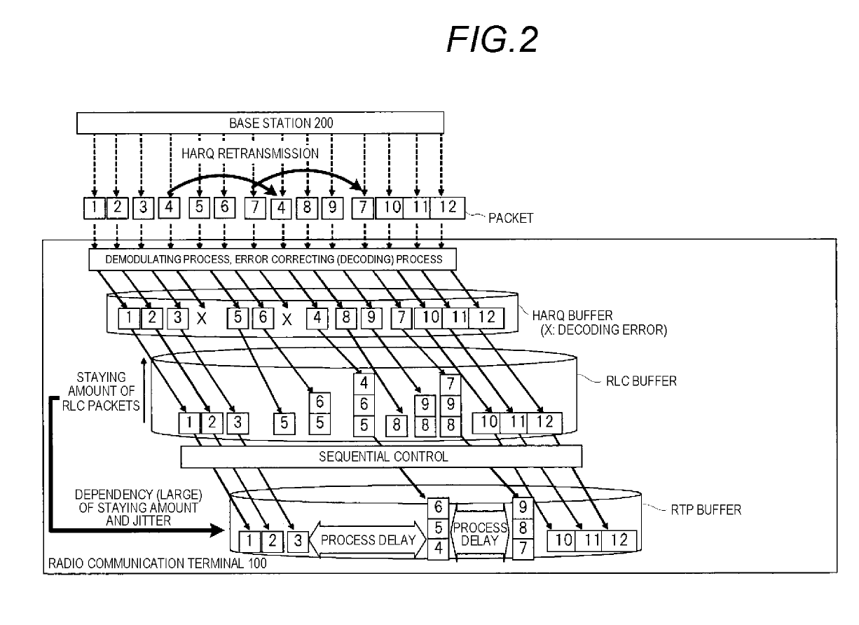

Hereinafter, referring to FIG. 2, an operation example of the radio communication terminal 100 according to the first embodiment will be described. FIG. 2 shows an aspect in which packets are accumulated in the buffers of the radio communication terminal 100. In FIG. 2, the radio communication terminal 100 sequentially receives packets 1 to 12 from the base station 200 through the wireless network. In FIG. 2, it is assumed that, in the demodulation section 105 and the error correction section 109, an error-correction decoding error (hereinafter, referred to as decoding error) occurs in packet 4 and packet 7 in the packets 1 to 12.

The packets 1 to 3 in which a decoding error does not occur in the demodulation section 105 and the error correction section 109 are sequentially subjected to the process of the RLC section 117 and that of the UDP/IP section 119, and then accumulated as RTP packets 1 to 3 in the RTP buffer 137.

By contrast, with respect to the packet 4 in which a decoding error occurs in the demodulation section 105 and the error correction section 109, a NACK is transmitted from the antenna 101 to the base station 200 which is the transmission source of the packet 4, through the wireless network. Since the packet 4 cannot be decoded, the packet 5 and the packet 6 are subjected to the process of the MAC section 115, in advance of the packet 4. However, the packet 5 and the packet 6 are not subjected to the process of the RLC section 117 in which the sequence of packets is controlled, because the packet 4 cannot be decoded. After the RLC packet 5 and the RLC packet 6 are extracted in the MAC section 115, therefore, the RLC packet 5 and the RLC packet 6 are stayed in the RLC buffer 133.

The jitter-absorption buffer adjustment section 135 reads the data amount of the RLC packets which are stayed in the RLC buffer 133 (the data amount of the RLC packet 5 and the packet 6), from the RLC buffer 133.

Then, the base station 200 which receives the NACK with respect to the packet 4 retransmits the packet 4 to the radio communication terminal 100. The packet 4 which is retransmitted from the base station 200 is received by the radio communication terminal 100 through the antenna 101, and, after the decoding process of the demodulation section 105 and the error correction of the error correction section 109, transferred to the MAC section 115. In the MAC section 115, then, an RLC packet 4 is extracted from the packet 4. The RLC packet 4 which is extracted in the MAC section 115 is transferred to the RLC section 117, and accumulated in the RLC buffer 133.

In the RLC section 117, the RLC packets 4 to 6 which are accumulated in the RLC buffer 133 are rearranged in the correct sequence. Then, the RLC packets 4 to 6 are transferred to the UDP/IP section 119.

In the UDP/IP section 119, the IP and UDP headers of each of the RLC packets 4 to 6 which are transferred from the RLC section 117 are analyzed. In the UDP/IP section 119, moreover, RTP packets 4 to 6 are extracted from the RLC packets 4 to 6. Then, the RTP packets 4 to 6 are transferred to the RTP section 121.

The RTP packets 4 to 6 which are processed in the UDP/IP section 119 are once transferred from the RTP section 121 to the RTP buffer 137, and accumulated therein. The capacity of the RTP buffer 137 fluctuates on the basis of the data amount of the RLC packets stayed in the RLC buffer 133, and is determined by the jitter-absorption buffer adjustment section 135.

In accordance with the output rate which is preset to a predetermined value, the RTP section 121 transfers the RTP packets which are stayed in the RLC buffer 133, to the decoder 123. Then, the decoder 123 converts the RTP packets to an audio signal or a video signal.

The radio communication terminal 100 performs a process similar to that on the packets 4 to 6, on the packets 7 to 9. Namely, with respect to the packet 7 in which a decoding error occurs, the radio communication terminal 100 transmits a NACK to the base station 200 which is the transmission source.

Since the packet 7 is missed, the radio communication terminal 100 stays the packet 8 and the packet 9 in the RLC buffer 133. The RLC buffer 133 informs the jitter-absorption buffer adjustment section 135 which will be described later, of the data amount of the RLC packets which are stayed in the RLC buffer 133 (the data amount of the RLC packet 8 and the packet 9). When the radio communication terminal 100 receives the packet 7 which is retransmitted from the base station 200, the radio communication terminal rearranges the packet 7 together with the packet 8 and packet 9 which are accumulated in the RLC buffer 133, in the correct sequence in the RLC section 117.

As described above, on the basis of the staying amount of the RLC packets in the RLC buffer 133, the jitter-absorption buffer adjustment section 135 controls the capacity of RTP packets which are accumulated in the RTP buffer 137. The reason for performing such a control will be described with reference to FIGS. 2 to 4.

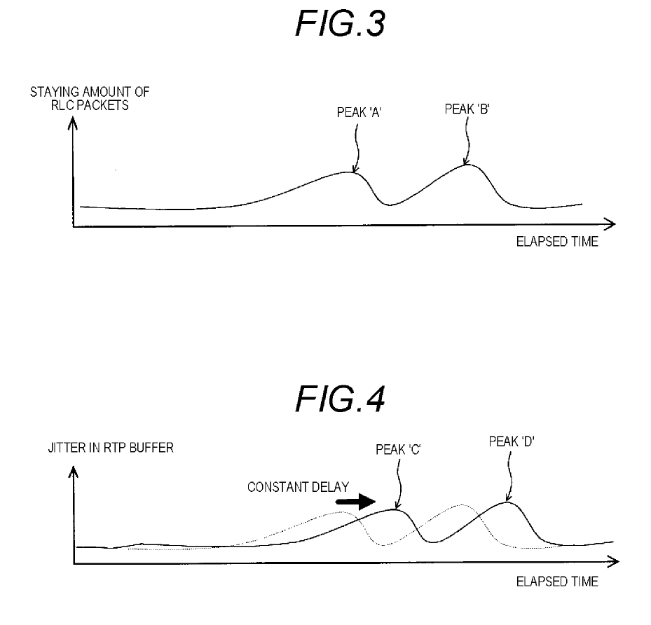

FIG. 3 shows temporal transition of the staying amount of the RLC packets in the RLC buffer 133. The ordinate indicates the staying amount of the RLC packets in the RLC buffer 133, and the abscissa indicates the elapsed time. As shown in FIG. 3, the staying amount of the RLC packets in the RLC buffer 133 has two peaks or peak ‘A’ and peak ‘B’. The first peak ‘A’ corresponds to the time when the packets 4 to 6 are stayed in the RLC buffer 133 in FIG. 2, or namely indicates the data amount of the packets 4 to 6 stayed in the RLC buffer 133. The second peak ‘B’ corresponds to the time when the packets 7 to 9 are stayed in the RLC buffer 133 in FIG. 2, or namely indicates the data amount of the packets 7 to 9 stayed in the RLC buffer 133.

Next, FIG. 4 shows temporal transition of the process delay (hereinafter, referred to as jitter) in the RTP buffer 137. The ordinate indicates jitter in the RTP buffer 137, and the abscissa indicates the elapsed time in the same manner as FIG. 3. In FIG. 4, the temporal transition of jitter in the RTP buffer 137 is indicated by the solid line. For comparison, in FIG. 4, the waveform of the temporal transition of the staying amount of the RLC packets in the RLC buffer 133 in FIG. 3 is indicated by the dash-dot line.

Here, jitter in the RTP buffer 137 means the time period from, for example, the timing when the packet 3 which is received immediately before the packet 4 is accumulated in the RTP buffer 137, to when the packet 5 and packet 6 which are stayed in the RLC buffer 133, and the packet 4 which is enabled to be decoded are accumulated in the RTP buffer 137.

As shown in FIG. 4, there are two peaks or peak ‘C’ and peak ‘D’. The first peak ‘C’ indicates the time period from, as described above, the timing when the packet 3 is accumulated in the RTP buffer 137, to when the RLC packet 5 and RLC packet 6 which are stayed in the RLC buffer 133, and the packet 4 which is enabled to be decoded are accumulated in the RTP buffer 137. The second peak ‘D’ indicates the time period from the timing when the packets 4 to 6 are accumulated in the RTP buffer 137, to when the RLC packet 8 and RLC packet 9 which are stayed in the RLC buffer 133, and the packet 7 which is enabled to be decoded are accumulated in the RTP buffer 137.

Hereinafter, FIGS. 3 and 4 will be compared with each other. It is found that the temporal transition of the staying amount of the RLC packets in the RLC buffer 133 that is indicated by the dash-dot line in FIG. 4 shows a waveform which is substantially identical with the temporal transition of jitter of the RTP buffer 137 that is indicated by the solid line in FIG. 4 by being shifted by a predetermined time period. Namely, it is found that the staying amount of the RLC packets in the RLC buffer 133 depends largely on jitter of the RTP buffer 137. Therefore, the radio communication terminal 100 according to the first embodiment controls the capacity of RTP packets accumulated in the RTP buffer 137, on the basis of the staying amount of the RLC packets in the RLC buffer 133. Consequently, the radio communication terminal 100 according to the first embodiment can adequately control the process delay (jitter) in the RTP buffer 137 in accordance with the capacity of the RTP buffer 137.

In the case where packets constitute AV data for stream reproduction, particularly, the buffer controller of the radio communication terminal 100 adequately controls the process delay (jitter) in the RTP buffer 137, whereby the rate of outputting RTP packets to the decoder 123 can be prevented from being lowered. As a result, the radio communication terminal 100 according to the first embodiment can prevent the rate of outputting audio and video data which are converted by the decoder 123, to the speaker 129 and the display 127 from being lowered.

### Embodiment 2

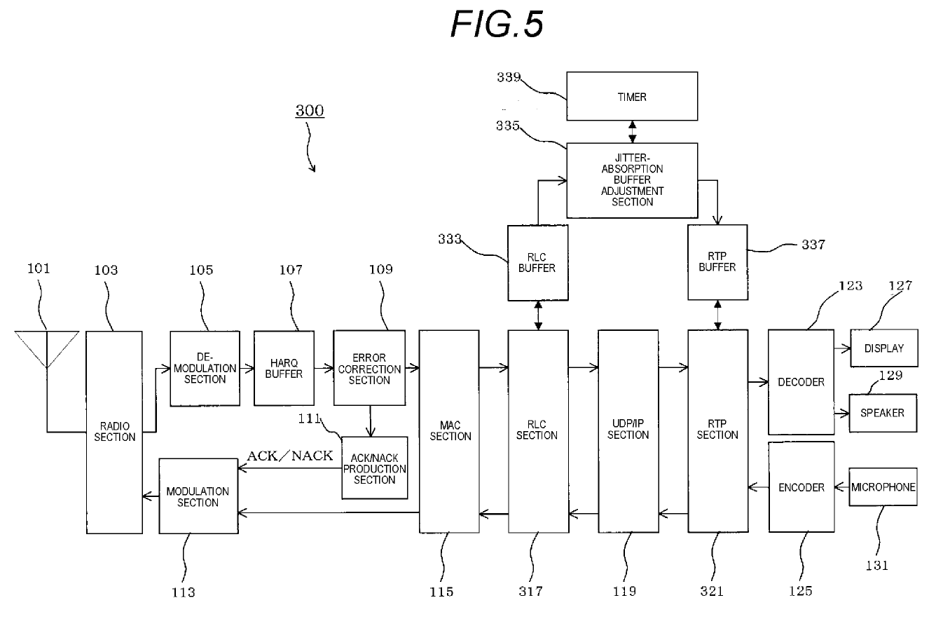

FIG. 5 is a block diagram of the configuration of a radio communication terminal 300 according to a second embodiment. The radio communication terminal 300 according to the second embodiment is different from the radio communication terminal 100 according to the first embodiment in that the terminal includes an RLC section 317, an RLC buffer 333, a jitter-absorption buffer adjustment section 335, an RTP section 321, an RTP buffer 337, and a timer 339, in place of the RLC section 117, the RLC buffer 133, the jitter-absorption buffer adjustment section 135, the RTP section 121, and the RTP buffer 137. The embodiment is identical with the first embodiment except this point. In FIG. 5, the components which are common with FIG. 1 are denoted by the same reference numerals.

Referring to FIG. 5, the components of the radio communication terminal 300 will be described.

In order to perform a sequential control on the RLC packets, the RLC section 317 accumulates the RLC packets in the RLC buffer 333. When the sequence of the RLC packets which are accumulated in the RLC buffer 333 is correct, the RLC section 317 sequentially transfers the RLC packets to the UDP/IP section 119. When the sequence of the RLC packets which are accumulated in the RLC buffer 333 is not correct, the RLC section 317 stays the RLC packets in the RLC buffer 333 until a missing packet is transferred from the MAC section 115.

The jitter-absorption buffer adjustment section 335 reads the data amount of the RLC packets which are stayed in the RLC buffer 333. In accordance with the staying amount of the RLC packets which are stayed in the RLC buffer 333, the jitter-absorption buffer adjustment section 335 controls the capacity of the RTP buffer 337. Furthermore, the jitter-absorption buffer adjustment section 335 controls the RLC packets which are stayed in the RLC buffer 333, by means of the timer 339.

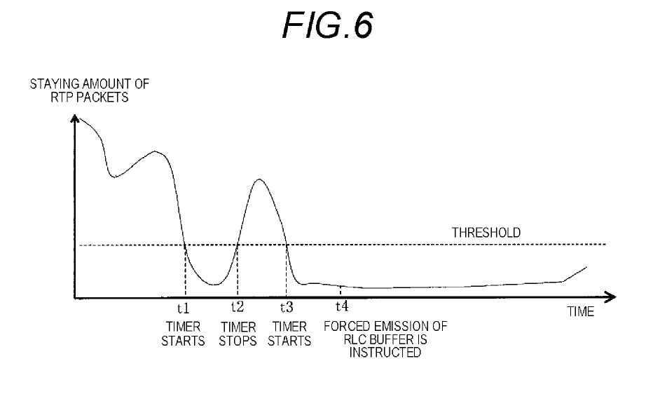

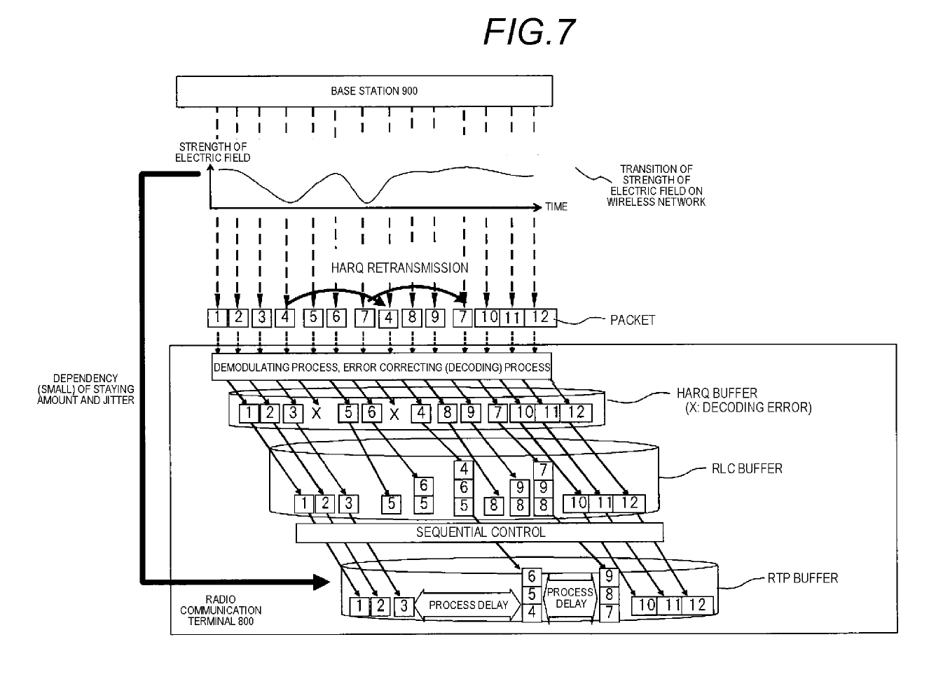

Referring to FIG. 6, the relationship between the operation of the timer 339 and the remaining amount of RTP packets in the RTP buffer 337 will be described. FIG. 6 shows temporal transition of the remaining amount of RTP packets in the RTP buffer 337.

Referring to FIG. 6, the timer 339 measures a time period (t2−t1) from a time t1 when the remaining amount of RTP packets in the RTP buffer 337 is reduced below a certain threshold, to a time t2 when the remaining amount is next increased above the certain threshold. The jitter-absorption buffer adjustment section 335 sets the time period (t2−t1) when the timer 339 time-outs.

The jitter-absorption buffer adjustment section 335 controls the timer 339 so as to start the measurement of the time period (t2−t1) when the timer 339 time-outs, at a time t3 when, after the time t2, the remaining amount of RTP packets in the RTP buffer 337 is initially reduced below the certain threshold.

When, after the time t3, the time-out time period (t2−t1) is elapsed from the time t3 while the remaining amount of RTP packets in the RTP buffer 337 is kept below the certain threshold, i.e., at a time t4, the jitter-absorption buffer adjustment section 335 forcibly transfers RLC packets which are stayed in the RLC buffer 333, to the RTP buffer 337.

The UDP/IP section 119 analyzes the IP/UDP headers of the RLC packets which are transferred from the RLC section 317. Furthermore, the UDP/IP section 119 extracts RTP packets from the RLC packets which are transferred from the RLC section 317. Then, the UDP/IP section 119 transfers the RTP packets extracted from the RLC packets, to the RTP section 321.

In accordance with the capacity of the RTP buffer 337 which is instructed by the jitter-absorption buffer adjustment section 335, the RTP section 321 accumulates the RTP packets which are transferred from the RTP section 321, in the RTP buffer 337. In accordance with a predetermined output rate, furthermore, the RTP section 321 transfers the RTP packets which are accumulated in the RTP buffer 337, to the decoder 123.

In the radio communication terminal 300 according to the second embodiment, as described above, in the case where the remaining amount of RTP packets in the RTP buffer 337 is smaller than the certain threshold for a predetermined time period, the jitter-absorption buffer adjustment section 335 forcibly transfers RLC packets which are stayed in the RLC buffer 333, to the UDP/IP section 119. Thereafter, the RLC packets are subjected to the process in the UDP/IP section 119, then converted to RTP packets in the RTP section 321, and transferred to the decoder 123. The buffer controller of the radio communication terminal 300 according to the second embodiment, therefore, can maintain the predetermined output rate of the RTP section 321.

Therefore, the buffer controller of the radio communication terminal 300 according to the second embodiment can adequately control the process delay (jitter) in the RTP buffer 337 in accordance with the capacity of the RTP buffer 337, while maintaining the predetermined output rate of the RTP section 321. In the case where packets constitute AV data for stream reproduction, particularly, the buffer controller of the radio communication terminal 300 according to the second embodiment adequately controls the process delay (jitter) in the RTP buffer 337, whereby the rate of outputting RTP packets to the decoder can be prevented from being lowered. Therefore, the radio communication terminal 300 according to the second embodiment can prevent the rate of outputting audio and video data which are converted by the decoder 123, to the speaker 129 and the display 127 from being lowered.

Typically, the functional blocks which are used in the descriptions of the embodiments are realized in the form of an LSI which is an integrated circuit. They may be individually integrated in one chip, or part or all of them may be integrated in one chip. Although such an integrated circuit is referred to as an LSI, such an integrated circuit may be called an IC, a system LSI, a super LSI, or an ultra LSI depending on the degree of integration.

The method of realizing such an integrated circuit is not limited to an LSI, and the integrated circuit may be realized by a dedicated circuit or a general-purpose processor. Alternatively, it is also possible to use an FPGA (Field Programmable Gate Array) which can be programmed after the production of the LSI, or a reconfigurable processor in which the connections or settings of circuit cells in the LSI can be reconfigured.

Furthermore, with the advancement of semiconductor technologies or other technologies derived therefrom, when integrated circuit technologies which replace LSIs emerge, it is a matter of course that the functional blocks may be integrated using such technologies. The applications of biotechnologies, and the like are possible.

The present invention has been explained in detail with reference to the particular embodiments. However, it is obvious for those skilled in the art that various variations and modifications can be applied without departing from the spirit and the scope of the present invention.

This application is based upon and claims the benefit of priority of Japanese Patent Application No. 2009-007748 filed on Jan. 16, 2009, the contents of which are incorporated herein by reference in its entirety.

### INDUSTRIAL APPLICABILITY

The buffer controller and radio communication terminal according to the invention can absorb jitter, and are applicable in a portable radio communication terminal which outputs AV data, and the like.

### REFERENCE SIGNS LIST

100, 300, 800 radio communication terminal
101 antenna
103 radio section
105 demodulation section
107 HARQ buffer
109 error correction section
111 ACK/NACK production section
113 modulation section
115 MAC section
117, 317 RLC section
119 UDP/IP section
121, 321 RTP section
123 decoder
125 encoder
127 display
129 speaker
131 microphone
133, 333 RLC buffer
135, 335 jitter-absorption buffer adjustment section
137, 337 RTP buffer
200, 900 base station
339 timer

1. A buffer controller provided in a communication terminal having a receiver that receives data through a network, the buffer controller comprising:
a first data processing section which includes a first buffer that, in order to rearrange the data received by the receiver in a correct sequence, stays the data, and which performs a process of rearranging the data that are stayed in the first buffer, in the correct sequence;
a second data processing section which includes a second buffer that buffers the data processed in the first data processing section, and which performs a process of outputting the data buffered in the second buffer, in accordance with a predetermined output rate; and
a controller which, based on an amount of the data stayed in the first buffer, controls at least a capacity of the second buffer.

2. The buffer controller according to claim 1, wherein
the controller controls the second processing section so as to, as a staying amount of the data which is stayed in the first buffer is larger, further increase the capacity of the second buffer.

3. The buffer controller according to claim 2, wherein
the controller controls the second processing section so as to, as the staying amount of the data which is stayed in the first buffer is smaller, further decrease the capacity of the second buffer.

4. The buffer controller according to claim 1, wherein
the buffer controller further comprises a decoder which converts the data processed in the second data processing section, to an audio signal and a video signal, and,
in a case where a data amount of the data per unit of time which are output from the second data processing section to the decoder is smaller than an output rate that is preset to a predetermined value, the controller controls the first processing section so as to output the data stayed in the first buffer, to the second buffer.

5. A radio communication terminal including the buffer controller according to claim 1.

6. A radio communication terminal including the buffer controller according to claim 2.

7. A radio communication terminal including the buffer controller according to claim 3.

8. A radio communication terminal including the buffer controller according to claim 4.
